(19) United States
(12) Patent Application Publication
(10) Pub. No.: US 2026/0193091 A1
(43) Pub. Date: Jul. 9, 2026

(54) METHODS FOR MAKING NANO-SIZED MESOPOROUS ZEOLITE BETA THAT UTILIZE HDYROTHERMAL TREATMENTS TO RE-INSERT ALUMINUM AND INCREASE CRYSTALLINITY

(71) Applicant: Saudi Arabian Oil Company, Dhahran (SA)

(72) Inventors: Lianhui Ding, Al Khobar (SA); Batool Altaher, Dammam (SA); Faisal Alotaibi, Al Khobar (SA); Faisal M. Almulla, Dhahran (SA)

(73) Assignee: Saudi Arabian Oil Company, Dhahran (SA)

(21) Appl. No.: 19/014,469

(22) Filed: Jan. 9, 2025

(51) Int. Cl. C01B 39/04

(52) U.S. Cl. CPC C01B 39/04; C01P 2002/86; C01P 2006/12; C01P 2006/14; C01P 2006/16

(57) ABSTRACT

Described herein are nano-sized mesoporous zeolite Beta that may be made by a method that includes producing a precursor nano-sized zeolite Beta by a process including hydrothermally treating a mixture including a templating agent, a silica source material, an alumina source material, and water. The method may further include calcining the nano-sized zeolite Beta precursor to form a calcined nano-sized mesoporous zeolite Beta intermediate, wherein the calcining may be at a temperature of from 400° C. to 650° C. The calcining may remove framework aluminum from the nano-sized zeolite Beta precursor. The calcined nano-sized mesoporous zeolite Beta intermediate may have a lesser relative crystallinity than the nano-sized zeolite Beta precursor. The method may further include mixing the calcined nano-sized mesoporous zeolite Beta intermediate with water, and hydrothermally treating the calcined nano-sized mesoporous zeolite Beta intermediate to from the nano-sized mesoporous zeolite Beta. The hydrothermal treatment of the calcined nano-sized mesoporous zeolite Beta intermediate may be at a temperature of from 100° C. to 350° C., wherein no additional water is added to the calcined nano-sized mesoporous zeolite Beta intermediate during the hydrothermal treatment. The hydrothermal treatment may re-inserts aluminum into the framework of the calcined nano-sized mesoporous zeolite Beta intermediate. The nano-sized mesoporous zeolite Beta may have greater relative crystallinity than the calcined nano-sized mesoporous zeolite Beta intermediate.

### BACKGROUND

### Field

The present disclosure generally relates to porous materials and, more particularly, to zeolites.

### Technical Background

There are numerous zeolitic materials, which are classified by framework type and composition. One such zeolitic material is zeolite Beta, which is a type of crystallized aluminosilicate zeolite that is widely used in heavy oil conversion processes such as hydrocracking and fluid catalytic cracking. The feedstock to these processes can be, for example, a portion of crude oil that has an initial boiling point of 350 Celsius (° C.) and an average molecular weight ranging from about 200 to 600, or greater. As such, zeolite Beta has an important use in industry in crude oil refining, and beyond.

### BRIEF SUMMARY

As described herein, nano-sized mesoporous zeolite Beta have been generated where a calcining step is utilized. It has been presently discovered that such a calcining step may reduce crystallinity of the nano-sized mesoporous zeolite Beta, according to one or more embodiments. Such reduction in crystallinity is undesirable for many use cases of zeolite Beta, such as catalysis. Embodiments described herein may be utilized to reverse such de-crystallization that is caused by calcining. In particular, it has been discovered that treating the nano-sized mesoporous zeolite Beta with a relatively low temperature hydrothermal treatment (e.g., less than 350° C.) may, surprisingly, improve crystallization by re-aluminating the zeolite Beta framework structure. On the other hand, it is believed that hydrothermal treatments at relatively high temperatures do not improve crystallinity by re-alumination, or at least do not improve crystallinity to the degree of the embodiments presently disclosed utilizing relatively low-temperature hydrothermal treatments.

In accordance with one embodiment of the present disclosure, nano-sized mesoporous zeolite Beta may be made by a method that comprises producing a precursor nano-sized zeolite Beta by a process comprising hydrothermally treating a mixture comprising a templating agent, a silica source material, an alumina source material, and water. The method may further comprise calcining the nano-sized zeolite Beta precursor to form a calcined nano-sized mesoporous zeolite Beta intermediate, wherein the calcining may be at a temperature of from 400° C. to 650° C. The calcining may remove framework aluminum from the nano-sized zeolite Beta precursor. The calcined nano-sized mesoporous zeolite Beta intermediate may have a lesser relative crystallinity than the nano-sized zeolite Beta precursor. The method may further comprise mixing the calcined nano-sized mesoporous zeolite Beta intermediate with water, and hydrothermally treating the calcined nano-sized mesoporous zeolite Beta intermediate to from the nano-sized mesoporous zeolite Beta. The hydrothermal treatment of the calcined nano-sized mesoporous zeolite Beta intermediate may be at a temperature of from 100° C. to 350° C., wherein no additional water is added to the calcined nano-sized mesoporous zeolite Beta intermediate during the hydrothermal treatment. The hydrothermal treatment may re-inserts aluminum into the framework of the calcined nano-sized mesoporous zeolite Beta intermediate. The nano-sized mesoporous zeolite Beta may have greater relative crystallinity than the calcined nano-sized mesoporous zeolite Beta intermediate.

Additional features and advantages of the technology disclosed herein will be set forth in the detailed description which follows, and in part will be readily apparent to those skilled in the art from that description or recognized by practicing the technology as described herein, including the detailed description which follows, as well as the appended claims.

It is to be understood that both the foregoing general description and the following detailed description present embodiments of the technology, and are intended to provide an overview or framework for understanding the nature and character of the technology as it is claimed. Additionally, following descriptions are meant to be merely illustrative, and are not intended to limit the scope of the claims in any manner.

### DETAILED DESCRIPTION

The present disclosure describes various embodiments for making nano-sized mesoporous zeolite Beta that utilize a hydrothermal treatment at relatively low temperatures following calcining of a precursor zeolite Beta. In general, and as described herein, the methods for making nano-sized mesoporous zeolite Beta may include an initial step of calcining a precursor nano-sized zeolite Beta to form a calcined nano-sized zeolite Beta intermediate material, and at least a second step of hydrothermally treating the calcined nano-sized mesoporous zeolite Beta intermediate at relatively low temperatures, such as less than or equal to 350° C.

Without being bound by any particular theory, it is believed that calcining the precursor nano-sized zeolite Beta de-aluminates the zeolite Beta by removing aluminum atoms from the framework and, thus, creates non-framework aluminum atoms present on the zeolite but not in the framework structure, which is believed to reduce crystallinity of the zeolite Beta. Such a calcining step may be needed to remove organic compounds present in the precursor nano-sized zeolite Beta and, in some embodiments, may be unavoidable. However, such reduced crystallinity is not desirable, and may cause lower efficiency for catalytic cracking of hydrocarbons.

According to various embodiments described herien, it has been presently discovered that a post-calcining hydrothermal treatment at relatively low temperatures may increase crystallinity of the nano-sized zeolite Beta as compared with the calcined nano-sized mesoporous zeolite Beta intermediate. Without being bound by theory, it is believed that the hydrothermal treatment at 350° C. or less re-inserts non-framework aluminum into the zeolitic framework, thus, increasing crystallinity. As compared with other conventional methods for making nano-sized mesoporous zeolite having relatively high crystallinity, the presently disclosed methods may be simpler, cheaper, and easier scaled.

As used throughout this disclosure, and as would be understood by those skilled in the art, “zeolites” may refer to micropore-containing inorganic materials with regular intra-crystalline cavities and channels of molecular dimension. As is understood by those skilled in the art, and as used in this disclosure, “zeolite Beta” refers to a type of zeolite having a *BEA framework type according to the International Zeolite Association (“IZA”) zeolite nomenclature and consisting majorly of silica and alumina. The molar ratio of silica to alumina in the zeolite Beta may be 5 or greater, 10 or greater, 25 or greater, or even 100 or greater. For example, the molar ratio of silica to alumina in the zeolite Beta may be from 5 to 500, such as from 10 to 50. Silica to Alumina ratio can be measured by X-ray Fluorescence (“XRF”) spectrometry, as would be understood by those skilled in the art.

In one or more embodiments, the zeolites described herein may be “mesoporous zeolites,” which refers to zeolites that have an average pore size of from 2 nm to 50 nm (the mesoporous range as recognized by IUPAC). Zeolites generally comprise a crystalline structure, as opposed to an amorphous structure such as what may be observed in some porous materials such as amorphous silica. Zeolites generally include a microporous framework which may be identified by a framework type. The microporous structure of zeolites (e.g., 0.3 nm to 2 nm pore size) may render large surface areas and desirable size-/shape-selectivity, which may be advantageous for catalysis. In embodiments described herein, the zeolites may include micropores (present in the microstructure of a zeolite), and additionally include mesopores. As used throughout this disclosure, micropores refer to pores in a structure that have a diameter of less than or equal to 2 nm and greater than or equal to 0.1 nm, and mesopores refer to pores in a structure that have a diameter of greater than 2 nm and less than or equal to 50 nm. The average pore size, which is how pore sized is characterized herein unless stated otherwise, may be determined by Brunauer-Emmett-Teller (BET) analysis, which is a classification technique that is well understood by those skilled in the art.

As described herein, “nano-sized” refers to zeolitic particles and/or crystals that have an average particle size of less than or equal to 100 nm, where the average is utilized to classify size since the zeolitic particles, when produced, are generally dispersed in size in a distribution, such as a normal distribution. In some embodiments, the precursor nano-sized mesoporous zeolite Beta, calcined nano-sized mesoporous zeolite Beta intermediate, and/or the ultimately formed nano-sized mesoporous zeolite Beta may have an average particle size ranging from 10 to 100 nm, such as from 20 nm to 100 nm, from 30 nm to 100 nm, from 40 nm to 100 nm, from 50 nm to 100 nm, from 60 nm to 100 nm, from 70 nm to 100 nm, from 80 nm to 100 nm, from 90 nm to 100 nm, from 10 nm to 80 nm, from 10 nm to 70 nm, from 10 nm to 60 nm, from 10 nm to 50 nm, from 10 nm to 40 nm, from 10 nm to 30 nm, or from 10 nm to 20 nm. The nano-sized zeolite Beta described herein may form as particles that may be generally spherical in shape or irregular globular shaped (that is, non-spherical). In embodiments, the particles have a “particle size” measured as the greatest distance between two points located on a single zeolite particle. For example, the particle size of a spherical particle is equal to its diameter. In other shapes, the particle size is measured as the distance between the two most distant points of the same particle, where these points may lie on outer surfaces of the particle. Average particle size can be determined using Scanning Electron Microscopy (“SEM”), where the particle size is measured as the longest distance in any dimension of a particle.

Without being bound by theory, it is believed that the relatively small particle size allows for easier access by the molecules in heavy oil to active sites on the zeolite. For example, the increased external surface area may be caused by the small particle size, which may increase catalytic activity.

As described herein, in one or more embodiments, a precursor nano-sized zeolite Beta may be formed by a hydrothermal treatment process (separate from the later hydrothermal treatment at 350° C. or less following calcining). As described herein, a “precursor nano-sized zeolite Beta” refers to a nano-sized zeolite Beta that has not yet been calcined following its formation or following any subsequent treatment steps such as hydrothermal treatment. The precursor nano-sized zeolite Beta may be mesoporous (i.e., having an average pore size of from 2 nm to 50 nm) or may be microporous.

According to one or more embodiments, the precursor nano-sized zeolite Beta may be produced by forming a mixture comprising a templating agent, a silica source material, an alumina source material, and water, and hydrothermally treating the mixture containing at least the templating agent, the silica source material, the alumina source material, and water to form the precursor nano-sized zeolite Beta. As described herein, “hydrothermal treatment” refers to treatment under beat in a humid environment, such as in an autoclave. Such a process may be synonymous with steam treating or autoclaving. Following the hydrothermal treatment, the nano-sized zeolite Beta may be separated from the remaining liquids, washed, and/or dried.

According to some embodiments, the templating agent may be a quaternary ammonium salt such as tetraethylammonium hydroxide (TEAOH). In one or more embodiments, the silica source material may comprise sodium silicate, fumed silica, precipitated silica, colloidal silica, silica gels, zeolites, dealuminated zeolites, rice husk, silicon hydroxides, silicon alkoxides, or combinations thereof. In one or more embodiments, the alumina source material may comprise aluminates, alumina (e.g. powdered alumina), aluminum colloids, boehmites, pseudo-boehmites, aluminum hydroxides, aluminum salts, aluminum alkoxides, aluminum wire, alumina gels, zeolites, or combinations thereof.

According to one or more embodiments, the mixture containing at least the templating agent (such as TEAOH), the silica source material, the alumina source material, and water may have a molar ratio of these contents of 1 mole of the alumina source material, from 15 moles to 40 moles of the quaternary ammonium salt (such as from 15 moles to 30 moles, or from 30 moles to 40 moles), from 20 moles to 500 moles of the silica source material (such as from 20 moles to 250 moles, or from 250 moles to 500 moles), and from 500 moles to 1000 moles of water (such as from 500 moles to 750 moles, or from 750 moles to 1000 moles).

In embodiments, the mixture containing at least the quaternary ammonium salt, the silica source material, the alumina source material, and water may be hydrothermally treated (e.g., by autoclave) for 1 to 7 days at, for example, 40 rotations per minute (rpm) to 80 rpm (such as about 60 rpm) at 100° C. to 150° C. (such as from 130° C. to 150° C., or about 140° C.) to form the precursor nano-sized zeolite Beta. The hydrothermal treatment may effectively crystalize the source materials to form the zeolite. Without being bound by theory, the amount of agitation during hydrothermal treatment may affect zeolite particle size.

In some embodiments, prior to hydrothermal treatment, the mixture containing at least the templating agent, the silica source material, the alumina source material, and water may be aged, such as by stirring for 4 hours at room temperature, prior to hydrothermal treatment. It should be understood that the described autoclaving and aging steps may be modified to some degree depending upon the exact components of the mixture that is autoclaved and the desired zeolite crystal structure to be formed.

Following the hydrothermal treatment, the resulting precursor nano-sized zeolite Beta may be separated from the remaining liquids, washed, and/or dried. The separation may be by centrifuge, or any other suitable liquid/solids separation technique. Washing may be with deionized water until the pH level is lower than 9.0. Drying may comprise passive drying or heating in an oven at, for example about 110° C. (such as 50° C. to 150° C.).

Following formation of the precursor nano-sized zeolite Beta, the precursor nano-sized zeolite Beta may be calcined. For example, calcining may be at 400° C. to 650° C. for from 2 to 8 hours. As described herein, “calcining” refers generally to heating to elevated temperatures in the presence of oxygen, even if in limited amounts. Calcining can be performed in an oven, kiln, or the like. Calcining is sometimes referred to as calcination, and these terms should be considered as interchangeable in the present disclosure.

As described hereinabove, according to embodiments, the precursor nano-sized zeolite Beta may be calcined at a temperature of from 400° C. to 650° C., such as from 400° C. to 600° C., from 400° C. to 550° C., from 400° C. to 500° C., from 400° C. to 450° C., from 450° C. to 650° C., from 500° C. to 650° C., from 550° C. to 650° C., or from 600° C. to 650° C. The time of calcining may be from 2 hours to 8 hours, such from 2 hours to 6 hours, from 2 hours to 4 hours, from 4 hours to 8 hours, or from 6 hours to 8 hours. The calcining may be at a temperature ramp rate of from 1° C./min to 4° C./min, such as from 2° C./min to 4° C./min, from 3° C./min to 4° C./min, from 1° C./min to 3° C./min, or from 1° C./min to 2° C./min. Such calcining of the precursor nano-sized zeolite Beta may form the calcined nano-sized mesoporous zeolite Beta intermediate. As described herein, “intermediate material” refers to a material that is later processed, such as by the hydrothermal treatments described herein.

Without being bound by theory, the calcining may burn off organic compounds, such as the templating agent, that are within the pores of the zeolite Beta, thus increasing the average pore size, according to some embodiments. However, it is believed that such calcining may cause non-framework aluminum species to form on the calcined nano-sized mesoporous zeolite Beta intermediate. In particular, without being bound by theory, it is believed that Al species are generated due to dealumination, and some pores or channels are blocked by the species, and that during the calcining of zeolite beta, the templating agent (such as TEAOH) in cages or channels of the zeolite Beta is decomposed. In air, the TEAOH is decomposed via Hoffman elimination reactions: (C₂H₅)₄N⁺OH⁻→C₂H₄+(C₂H₅)₃N+H₂O. Still without being bound by theory, it is believed that produced water becomes steam, and leads to dealumination and partially destroys the zeolite framework structure.

According to embodiments, the calcining may remove framework aluminum from the nano-sized zeolite Beta precursor. Generally, a person skilled in the art can determine if and to the extent that framework aluminum is removed from a zeolite by crystallinity testing and by NMR testing. For example, lower crystallinity can be assumed to be caused by the removal of framework aluminum. Additionally, ²⁷Al NMR analysis can be conducted to determine the presence of non-framework aluminum present in a sample. In particular, peaks at about 0 ppm are indicative of non-framework aluminum present in a sample. Where a sample has reduced crystallinity and non-framework aluminum is present, it can be inferred that framework aluminum has been removed. Conversely, if NMR reveals a lack of non-framework alumina in a sample that previously had non-framework alumina, and the relatively crystallinity is increased, it can be inferred that non-framework alumina has been re-inserted into the microstructure of the zeolite.

As described herein, the relative crystallinity of a sample may be measured with XRD (X-ray Diffraction). The crystallinity is measured in relative terms based on, generally, in initial sample being assigned 100% crystallinity, where other samples are calculated as greater than 100% if they have greater crystallinity or under 100% if crystallinity is reduced. From the XRD spectra, the five most intensive peaks are integrated. The sample relative crystallinity is calculated based on the following equation: X (%)=100%×ΣA/ΣA₀, where A is the sum of the five peak total area of the fabricated samples; A₀ is the sum of the five peak total area of the reference sample.

According to embodiments, the calcined nano-sized mesoporous zeolite Beta intermediate may have decreased relative crystallinity as compared to the nano-sized zeolite Beta precursor. Additionally, the presence of non-framework alumina may be detected in greater amounts in the calcined nano-sized mesoporous zeolite Beta intermediate than in the nano-sized zeolite Beta precursor. In some embodiments, non-framework alumina is not detected in the nano-sized zeolite Beta precursor. According to some embodiments, the nano-sized zeolite Beta precursor may have a relative crystallinity of 2%, 5%, or even 10%, greater than that of the calcined nano-sized mesoporous zeolite Beta intermediate.

Following the calcining, the calcined nano-sized mesoporous zeolite Beta intermediate may be mixed with water. The mass ratio of water to calcined nano-sized mesoporous zeolite Beta intermediate may be from 0.5 to 3, such as from 0.5 to 1, from 1 to 2, from 2 to 3, or any combination of one or more of these ranges.

Following the mixing with water step, according to one or more embodiments, the calcined nano-sized mesoporous zeolite Beta intermediate may be hydrothermally treated at from 100° C. to 350° C. to form the nano-sized mesoporous zeolite Beta that is the product of the processes described herein. Without being bound by theory, it is believed that the hydrothermal treatment of the calcined nano-sized mesoporous zeolite Beta intermediate removes portion or all of the non-framework aluminum present in the calcined nano-sized mesoporous zeolite Beta intermediate and re-inserts this aluminum back into the zeolitic framework structure. Also, without being bound by theory, it is believed that hydrothermal treatment temperatures exceeding 350° C. may not as effectively re-insert aluminum atoms back into the zeolitic framework.

In further embodiments, the hydrothermal treatment of the calcined nano-sized mesoporous zeolite Beta intermediate may be performed at temperatures of 325° C. or less, 300° C. or less, 275° C. or less, 250° C. or less, 225° C. or less, 200° C. or less, 175° C. or less, or even 150° C. or less. In some embodiments, the hydrothermal treatment temperature may be from 250° C. to 350° C., or from 275° C. to 325° C., which may produce higher crystallinity products than other temperatures.

In embodiments, no additional water is added to the calcined nano-sized mesoporous zeolite Beta intermediate during the hydrothermal treatment. Conventional embodiments may utilize alternative processes which result in inferior crystallinity while also being, sometimes, more complex and/or expensive. Such conventional embodiments may utilize high temperature steam treatments that require additional water being added during hydrothermal treatment to maintain humidity. On the other hand, in some present embodiments, no additional water is added, where water used in the hydrothermal treatment is present in the zeolite, sometimes referred to as autogenerated steam.

According to one or more embodiments, the hydrothermal treatment of the calcined nano-sized mesoporous zeolite Beta intermediate may be for a time period of greater than 2 hours, greater than 5 hours, greater than 10 hours, or from 20 hours to 60 hours (e.g., from 20 to 30 hours, from 30 to 40 hours, from 40 to 50 hours, from 50 to 60 hours, or combinations of these ranges). In general, conventional embodiments may utilized shorter times.

As described herein, the presently described hydrothermal treatment at 350° C. or less may re-insert aluminum into the framework of the calcined nano-sized mesoporous zeolite Beta intermediate, such that the nano-sized mesoporous zeolite Beta has greater relative crystallinity than the calcined nano-sized mesoporous zeolite Beta intermediate. Such can be detected by those skilled in the art with NMR and relative crystallinity analysis, as described previously herein. For example, the presence of non-framework alumina may be detected in greater amounts in the calcined nano-sized mesoporous zeolite Beta intermediate than in the nano-sized mesoporous zeolite Beta product. In some embodiments, non-framework alumina is not detected in the nano-sized zeolite Beta. According to some embodiments, the nano-sized zeolite Beta product may have a relative crystallinity of 2%, 5%, or even 10%, greater than that of the calcined nano-sized mesoporous zeolite Beta intermediate.

Following the hydrothermal treatment, the nano-sized mesoporous zeolite Beta may be separated from the residual water from the hydrothermal treatment, washed, and/or dried. The separation may be by centrifuge, or any other suitable liquid/solids separation technique. Washing may be with deionized water until the pH level is lower than 9.0. Drying may comprise passive drying or heating in an oven at, for example, 100-120° C.

According to embodiments, the presently disclosed methods may not utilize a structure-directing agent, which may be costly and undesirable. Such structure directing agents may be organic nitrogen-containing structure directing agent, such as amines, such as diethylamine or 1,6-diaminohexane, an alkanolamine, such as diethanolamine, 1,8-diamino-octane, N-Ethylpyridine, or a tetraalkyl ammonium compound, such as tetrapropylammonium hydroxide (TPAOH).

In one or more embodiments, the nano-sized mesoporous zeolite Beta described herein may have an average pore volume of 0.9 mL/g or greater, such as from 0.9 to 3.0 mL/g, from 1 to 3.0 mL/g, from 1.1 to 3.0 mL/g, or from 1.2 to 3.0 mL/g. As used in this disclosure, “pore volume” refers to the total pore volume measured using BET analysis, as is understood by those skilled in the art.

Without being bound they theory, it is believed that the relatively large pore size (that is, mesoporosity) of the presently described nano-sized mesoporous zeolite Beta and catalysts that include the nano-sized mesoporous zeolite Beta allows for larger molecules to diffuse inside the zeolite, which is believed to enhance the reaction activity and selectivity of the zeolite. With the increased pore size, aromatic containing molecules can more easily diffuse into the zeolite and aromatic cracking may be increased. For example, in some conventional embodiments, the feedstock converted by the zeolites may be vacuum gas oils, light cycle oils from, for example, a fluid catalytic cracking reactor, or coker gas oils from, for example, a coking unit. The molecular sizes in these oils are relatively small compared to those of heavy oils such as crude and atmosphere residue, which may be the feedstock of the presently described methods and systems. The heavy oils generally are not able to diffuse inside the conventional zeolites to be converted on the active sites located inside the zeolites. Therefore, zeolites with larger pore sizes (that is, mesoporous zeolites) may make the larger molecules of heavy oils overcome the diffusion limitation, and may make possible reaction and conversion of the larger molecules of the heavy oils.

In additional embodiments, the nano-sized, mesoporous zeolites described herein may have an average surface area of 600 m²/g or greater, such as from 600 m²/g to 700 m²/g. For example, embodiments of the nano-sized, mesoporous zeolite Beta may have a surface area of from 500 m²/g to 550 m²/g, from 500 m²/g to 600 m²/g, from 500 m²/g to 650 m²/g, from 550 m²/g to 700 m²/g, from 600 m²/g to 700 m²/g, or from 650 m²/g to 700 m²/g. Average surface area can be measured by BET analysis, as is known by those skilled in the art. Increased surface area may increase catalytic effectiveness, and is generally desirable.

According to one or more embodiments, the produced nano-sized, mesoporous zeolites described herein may be utilized in hydrocracking operations. Hydrocracking is a process combining catalytic cracking and hydrogenation, wherein heavier feedstocks are cracked in the presence of hydrogen to produce more desirable products. This is an important technology for producing high-value naphtha or distillate products from a wide range of refinery feedstocks. According to embodiments, hydrocracking catalysts may utilize zeolite Beta as their cracking component. The high acidity and hydrothermal stability of zeolite Beta make it a desirable catalyst component in hydrocracking, fluid catalytic cracking, hydrotreating, and isobutene alkylation.

Numerous technical aspects are disclosed herein, including Aspects 1-20, described herein below.

Aspect 1. A method for making nano-sized mesoporous zeolite Beta, the method comprising: producing a precursor nano-sized zeolite Beta by a process comprising hydrothermally treating a mixture comprising a templating agent, a silica source material, an alumina source material, and water; calcining the nano-sized zeolite Beta precursor to form a calcined nano-sized mesoporous zeolite Beta intermediate, wherein the calcining is at a temperature of from 400° C. to 650° C., and wherein: the calcining removes framework aluminum from the nano-sized zeolite Beta precursor; and the calcined nano-sized mesoporous zeolite Beta intermediate has a lesser relative crystallinity than the nano-sized zeolite Beta precursor; mixing the calcined nano-sized mesoporous zeolite Beta intermediate with water; hydrothermally treating the calcined nano-sized mesoporous zeolite Beta intermediate to from the nano-sized mesoporous zeolite Beta, wherein the hydrothermal treatment of the calcined nano-sized mesoporous zeolite Beta intermediate is at a temperature of from 100° C. to 350° C., wherein no additional water is added to the calcined nano-sized mesoporous zeolite Beta intermediate during the hydrothermal treatment, and wherein: the hydrothermal treatment re-inserts aluminum into the framework of the calcined nano-sized mesoporous zeolite Beta intermediate; and the nano-sized mesoporous zeolite Beta has greater relative crystallinity than the calcined nano-sized mesoporous zeolite Beta intermediate.

Aspect 2. The method of any previous Aspect, wherein the he hydrothermal treatment of the calcined nano-sized mesoporous zeolite Beta intermediate is at temperatures of 200° C. or less.

Aspect 3. The method of any previous Aspect, wherein the hydrothermal treatment of the calcined nano-sized mesoporous zeolite Beta intermediate is for a time period of greater than 2 hours.

Aspect 4. The method of any previous Aspect, wherein the hydrothermal treatment of the calcined nano-sized mesoporous zeolite Beta intermediate is for a time period of from 20 hours to 60 hours.

Aspect 5. The method of any previous Aspect, wherein the hydrothermal treatment of the calcined nano-sized mesoporous zeolite Beta intermediate is in an autoclave.

Aspect 6. The method of any previous Aspect, wherein the ratio of water to calcined nan-sized mesoporous zeolite Beta in the mixing is from 0.5 to 3.

Aspect 7. The method of any previous Aspect, wherein the calcining of the precursor nano-sized zeolite Beta causes non-framework aluminum to form on the precursor nano-sized zeolite Beta.

Aspect 8. The method of any previous Aspect, wherein the method does not utilize a structure-directing agent.

Aspect 9. The method of any previous Aspect, wherein the mass ratio of water to calcined nano-sized mesoporous zeolite Beta intermediate is from 0.5 to 3.

Aspect 10. The method of any previous Aspect, wherein the calcining is for a time period of from 2 hours to 8 hours.

Aspect 11. The method of any previous Aspect, wherein the templating agent is tetraethylammonium hydroxide.

Aspect 12. The method of any previous Aspect, wherein the silica source material is fumed silica

Aspect 13. The method of any previous Aspect, wherein the aluminum source material is aluminum powder.

Aspect 14. The method of any previous Aspect, wherein hydrothermally treating the mixture comprises autoclaving for 1 to 7 days at 100° C. to 150° C.

Aspect 15. The method of Aspect 14, wherein the mixture is agitated while being hydrothermally treated.

Aspect 16. The method of Aspect 15, wherein the mixture is agitated at 40 rpm to 80 rpm.

Aspect 17. The method of any previous Aspect, wherein the process for producing the nano-sized zeolite Beta further comprises separating the precursor nano-sized zeolite Beta from remaining liquids, washing the precursor nano-sized zeolite Beta, and drying the precursor nano-sized zeolite Beta.

Aspect 18. The method of any previous Aspect, wherein the nano-sized mesoporous zeolite Beta has an average particle size of from 10 nm to 100 nm.

Aspect 19. The method of any previous Aspect, wherein the nano-sized mesoporous zeolite Beta has an average surface area of 600 m²/g or greater.

Aspect 20. The method of any previous Aspect, wherein the nano-sized mesoporous zeolite Beta has pore volume of 0.9 ml/g or greater.

### EXAMPLES

The various embodiments of the methods of the present disclosure will be further clarified by the following examples. The examples are illustrative in nature, and should not be understood to limit the subject matter of the present disclosure.

### Example 1—Preparation of Precursor Nano-Sized Zeolite Beta Samples (Sample NanoB) and Calcining of Same

A non-calcined nano-sized zeolite Beta, termed Sample NanoB herein, was fabricated that was further heated in additional examples. The sample were prepared according to embodiments disclosed in Alotaibi et al. “A facile synthesis of hierarchical Nanosized Beta and its application in direct crude oil hydrocracking,” Catalyst Communications 2024, Vol. 187, 106871.

To make Sample NanoB, aluminum metal was dissolved in a TEAOH-containing aqueous solution, resulting in the formation of a transparent solution. Subsequently, this solution was introduced into a slurry composed of fumed silica and another portion of the TEAOH-containing aqueous solution. The silica source used was fumed silica (Degussa, Aerosil 200), whereas the aluminum source employed was aluminum powder. Additionally, tetraethylammonium hydroxide (TEAOH) (Aldrich, 35% aqueous solution) was utilized as the templating agent. The precursor gel was composed of oxides with the following molar ratio: 30TEAOH: 50SiO₂:Al₂O₃: 750H₂O. The aluminosilicate fluid gel that was created was agitated in a beaker at room temperature for 4 hours. Following, it was placed into a Teflon-lined autoclave. The process of crystallization was conducted at a temperature of 140° C. in a rotational state at a speed of 60 rpm for 3 days. The autoclave was subjected to quenching to stop the crystallization reaction. The separation of the finished product from the liquid was achieved by using a centrifuge operating at a speed of 16,000 rpm. Subsequently, the separated product underwent a washing process using deionized water until the pH level reached a value lower than 9.0. Finally, the product was subjected to a drying procedure in an oven at a temperature of 110° C.

The NanoB sample was then calcined at 600° C. for 4 hours to make sample NanoB-C.

The produced samples NanoB and NanoB-C were analyzed for various properties, shown in Table 1. Relative crystallinity for samples NanoB-C is compared with the baseline 100% for sample NanoB. Notably, it is seen that calcining caused substantial loss in crystallinity. For example, crystallinity in Sample NanoB when calcined was reduced from 100% to 90%. Additionally, NMR was utilized which revealed little or no presence of non-framework alumina is NanoB but a substantial amount of non-framework alumina in NanoB-C, versified by NMR as shown in Table 1.

TABLE 1

| Sample | NanoB | NanoB-C |
|---|---|---|
| Description | Non-Calcined | Calcined NanoB |
| | Nano-sized | |
| | Zeolite Beta | |
| Relative Crystallinity | 100% | 90% |
| Non-framework Al/total Al | 0 | 28.9 |
| in zeolite molar ratio* | | |
| SiO₂/Al₂O₃ Molar Ratio | 22.8 | 22.9 |
| Surface area, m²/g | 590 | 547 |
| Pore volume, ml/g | 0.83 | 1.15 |
| Average pore size, nm | 2.8 | 8.3 |

*based on ²⁷Al NMR

### Example 2—Hydrothermal Treatments of Calcined Precursor Nano-Sized Zeolite Beta Samples (Sample NanoB-C)

Sample NanoB-C from Example 1 was hydrothermally treated at varying temperatures. In particular, sample NanoB-C-150 was hydrothermally treated at 150° C., sample NanoB-C-300 was hydrothermally treated at 300° C., sample NanoB-C-550 was hydrothermally treated at 550° C.

To make samples NanoB-C-150 and NanoB-C-300, 3 g of the sample NanoB-C were placed into the sample holder of an autoclave vessel (140 ml). Then, 10 ml of water was added into the autoclave, and the holder was added into it, and the unit was sealed. The autoclave was placed in an oven and heated to 150° C. or 300° C. and maintained at those respective temperatures for 48 hours. The samples were then cooled to room temperature.

To make Sample NanoB-C-600, a comparative sample, the sample NanoB-C was hydrothermally treated. Specifically, the Sample NanoB was steamed using an autoclave reactor at a temperature 600° C. for one hour and the pressure was maintained at 1-2 bar throughout the treatment time by adjusting the pressure relief valve.

Table 2 depicts data related to these samples. All samples had an average particle size of about 60 nm. Crystallinity in Table 2 is calculated with sample NanoB-C as a baseline 100%. Notably, lower temperature hydrothermal treatments (at 150° C. and 300° C.) increased crystallinity much more than the higher temperature treatment at 600° C. Additionally, NMR analysis revealed small amounts of non-framework alumina in samples NanoB-C-150 and NanoB-C-300, while greater amounts of non-framework alumina was detected in NanoB-C-600.

TABLE 2

| | Sample name | | |
|---|---|---|---|
| | | | NanoB-C-600 |
| | NanoB-C-150 | NanoB-C-300 | (comparative) |
| Condition | | | |
| Temperature, ° C. | 150 | 300 | 600 |
| Steam pressure | Auto | Auto | 1-2 bar |
| Time, hour | 48 | 48 | 1 |
| Non-framework Al/ | 7.4 | 5.5 | 19.0 |
| total Al in zeolite | | | |
| molar ratio | | | |
| Product properties | | | |
| XRD crystallinity, % | 108 | 113 | 103 |
| SiO₂/Al₂O₃ ratio | 24.6 | 24.8 | 24.8 |
| Surface area, m2/g | 623 | 586 | 585 |
| Pore volume, ml/g | 1.21 | 1.15 | 1.09 |
| Average pore size, nm | 7.8 | 7.8 | 7.8 |

For the purposes of describing and defining the present disclosure it is noted that the terms “about” or “approximately” are utilized in this disclosure to represent the inherent degree of uncertainty that may be attributed to any quantitative comparison, value, measurement, or other representation. The terms “about” and/or “approximately” are also utilized in this disclosure to represent the degree by which a quantitative representation may vary from a stated reference without resulting in a change in the basic function of the subject matter at issue.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

It is also noted that recitations herein of “at least one” component, element, etc., should not be used to create an inference that the alternative use of the articles “a” or “an” should be limited to a single component, element, etc.

What is claimed is:

1. A method for making nano-sized mesoporous zeolite Beta, the method comprising:
producing a precursor nano-sized zeolite Beta by a process comprising hydrothermally treating a mixture comprising a templating agent, a silica source material, an alumina source material, and water;
calcining the nano-sized zeolite Beta precursor to form a calcined nano-sized mesoporous zeolite Beta intermediate, wherein the calcining is at a temperature of from 400° C. to 650° C., and wherein:
the calcining removes framework aluminum from the nano-sized zeolite Beta precursor; and
the calcined nano-sized mesoporous zeolite Beta intermediate has a lesser relative crystallinity than the nano-sized zeolite Beta precursor;
mixing the calcined nano-sized mesoporous zeolite Beta intermediate with water;
hydrothermally treating the calcined nano-sized mesoporous zeolite Beta intermediate to from the nano-sized mesoporous zeolite Beta, wherein the hydrothermal treatment of the calcined nano-sized mesoporous zeolite Beta intermediate is at a temperature of from 100° C. to 350° C., wherein no additional water is added to the calcined nano-sized mesoporous zeolite Beta intermediate during the hydrothermal treatment, and wherein:
the hydrothermal treatment re-inserts aluminum into the framework of the calcined nano-sized mesoporous zeolite Beta intermediate; and
the nano-sized mesoporous zeolite Beta has greater relative crystallinity than the calcined nano-sized mesoporous zeolite Beta intermediate.

2. The method of claim 1, wherein the he hydrothermal treatment of the calcined nano-sized mesoporous zeolite Beta intermediate is at temperatures of 200° C. or less.

3. The method of claim 1, wherein the hydrothermal treatment of the calcined nano-sized mesoporous zeolite Beta intermediate is for a time period of greater than 2 hours.

4. The method of claim 1, wherein the hydrothermal treatment of the calcined nano-sized mesoporous zeolite Beta intermediate is for a time period of from 20 hours to 60 hours.

5. The method of claim 1, wherein the hydrothermal treatment of the calcined nano-sized mesoporous zeolite Beta intermediate is in an autoclave.

6. The method of claim 1, wherein the ratio of water to calcined nan-sized mesoporous zeolite Beta in the mixing is from 0.5 to 3.

7. The method of claim 1, wherein the calcining of the precursor nano-sized zeolite Beta causes non-framework aluminum to form on the precursor nano-sized zeolite Beta.

8. The method of claim 1, wherein the method does not utilize a structure-directing agent.

9. The method of claim 1, wherein the mass ratio of water to calcined nano-sized mesoporous zeolite Beta intermediate is from 0.5 to 3.

10. The method of claim 1, wherein the calcining is for a time period of from 2 hours to 8 hours.

11. The method of claim 1, wherein the templating agent is tetraethylammonium hydroxide.

12. The method of claim 1, wherein the silica source material is fumed silica.

13. The method of claim 1, wherein the aluminum source material is aluminum powder.

14. The method of claim 1, wherein hydrothermally treating the mixture comprises autoclaving for 1 to 7 days at 100° C. to 150° C.

15. The method of claim 14, wherein the mixture is agitated while being hydrothermally treated.

16. The method of claim 15, wherein the mixture is agitated at 40 rpm to 80 rpm.

17. The method of claim 1, wherein the process for producing the nano-sized zeolite Beta further comprises separating the precursor nano-sized zeolite Beta from remaining liquids, washing the precursor nano-sized zeolite Beta, and drying the precursor nano-sized zeolite Beta.

18. The method of claim 1, wherein the nano-sized mesoporous zeolite Beta has an average particle size of from 10 nm to 100 nm.

19. The method of claim 1, wherein the nano-sized mesoporous zeolite Beta has an average surface area of 600 m²/g or greater.

20. The method of claim 1, wherein the nano-sized mesoporous zeolite Beta has pore volume of 0.9 ml/g or greater.
